(19) United States
(12) Patent Application Publication
(10) Pub. No.: US 2010/0300055 A1
(43) Pub. Date: Dec. 2, 2010

(54) Wide-span mowing device

(76) Inventor: Dan Dvorak, Mokena, IL (US)

Correspondence Address: Anne McGovern Burkhart;Carmen Patti Law Group, LLC, 44th Floor, One N. LaSalle Street, Chicago, IL, 60602, US

(21) Appl. No.: 12/455,078

(22) Filed: May 28, 2009

(51) Int. Cl. A01D 75/30

(52) U.S. Cl. 56/6

(57) ABSTRACT

A wide-span lawn mowing mechanism includes a chassis assembly having a front tube element, a rear tube element, and a plurality of cross tubes connecting the front tube element to the rear tube element. A plurality of rotary cutting heads are suspended from the chassis assembly. A power source is included for imparting rotary motion to the cutting heads. A selectively actuatable drive system operatively connects the cutting heads to the power source.

### CROSS-REFERENCE TO RELATED APPLICATION

None.

### BACKGROUND

Until the early 19^{th} century, the grass of lawns and sporting grounds was cut manually, with a scythe. In 1827, English engineer Edwin Budding, while visiting a textile mill, noticed a machine that was used to shear the nap of velvet. It occurred to Budding that the irregular, untrimmed nap resembled grass, and adapted the concept to produce a cylinder, or reel-type mower. Budding's machine included a series of blades arranged around a cylinder, with the cylinder spinning when the mower was pushed via a handle.

In 1870, Elwood McGuire of Richmond, Ind. designed a machine that was similar to reel-type mowers sold today. It was lighter, easier to operate, and mechanically simpler than Budding's machine and its early progeny. The McGuire machine soon began to be mass-produced, and by 1885, American factories were producing 50,000 lawnmowers a year.

The development in the late 19^{th} and early 20^{th} century of relatively small and efficient gasoline engines facilitated the invention of the power mower. In the United States, the first gasoline powered mowers were manufactured in 1919 by Colonel Edwin George. The Great Depression, and later WWII, prevented widespread adoption of power mowers. However, in the postwar period, the growth of suburbia, with its endless acres of lawns, created a demand for power mowers.

It was also in the early 20^{th} century that C. C. Worthington, renowned engineer and founder of the PGA, invented wide-span or “gang” mowers in response to the need to maintain golf course fairways. Worthington's first gang mower had three moving wheels and was pulled by a horse. by 1919, Worthington had designed a tractor to pull the mower. Worthington mowers then became the standard for golf course maintenance.

Since Worthington's time, the development of wide-span mowers has taken a variety of paths. In the most common configuration, a plurality of rotating blades are suspended from a large guard or housing.

The following patents provide some examples: U.S. Pat. No. 6,591,592 to Krimminger is directed to a mower assembly including a platform for being mounted on one side of a mobile machine and a housing concentrically mounted on the platform for rotation relative thereto. A drive assembly is positioned in the housing and is driven by a power supply. A blade is also included for being rotated by the drive assembly. A latch assembly is mounted on the housing for movement between a latched position for maintaining the housing in a stationary position relative to the platform in the absence of a laterally-directed force on the latch assembly, and an unlatched position for permitting the housing to rotate around the platform in the presence of a laterally-directed force on the latch assembly. This permits the blade to cut vegetation growing around the stationary object as the mobile machine continues in a straight line path.

U.S. Pat. No. 6,427,429 to Brabenec describes a multi-string lawnmower that has a multi-tiered housing to which is mounted to at least one electric motor coupled to a battery. There are a plurality of mandrel shafts arranged in rows mounted to bearings on the underside of the housing. The mandrel shafts are associated with roller guides and engage a serpentine belt, that is powered by the at least one electric motor. The serpentine belt imparts rotational motion to the mandrel shafts such that adjacent shafts rotate in opposite directions. The cutting elements or strings are attached to the mandrel shafts and are held in place by centrifugal force.

U.S. Pat. No. 6,336,312 to Bednar shows a gang-type rotary lawn mower including a frame supported by wheels for movement over the ground, a power source which is mounted on the frame and which drives at least two of the wheels, an operator's seat mounted on the frame, a steering system enabling the operator to steer the lawn mower, at least two side-by-side front rotary cutting deck assemblies mounted on the frame, the front deck assemblies defining a gap between adjacent front deck assemblies, and at least one rear rotary cutting deck assembly mounted on the frame behind the front deck assemblies, each rear deck assembly being aligned with a respective gap between adjacent front deck assemblies, each of the front and rear deck assemblies including a single-spindle mulching deck defining a downwardly opening space, a single spindle mounted for rotation about a generally vertical axis within the space, and at least one cutting blade mounted on the spindle for rotation therewith.

U.S. Pat. No. 5,471,824 to Neely discloses a trimming apparatus comprising a platform, a plurality of wheels and a plurality of cutters. The platform has a kickback capability and is biased into an operable position, but capable of kicking back when the apparatus contacts rigid obstacles during the trimming operation. The cutting elements include a plurality of flexible blades having a cutting radius larger than the guide disks which are provided to contact obstacle and help the invention be steered around such obstacles. Optional bumpers are provided to further enable the device to “ride over” obstacles and uneven ground terrain. An independent power source such as an electrical or combustible engine having a drive shaft connected to a drive pulley which in turn is interconnected with the cutting elements by a cutter pulley and idler pulley arrangement so as to maintain a desired tension on the drive belt during operation of the device. The cutting blades are pivotally mounted to the cutting pulleys so that they may free float and recoil in response to contacting rigid obstacles.

U.S. Pat. No. 5,146,733 to Klaeger involves a method and apparatus for mowing a wide swath which is preferably hydraulically powered to provide reliability, efficiency, and ease of operation. The apparatus includes a rear section, or chassis, to which side-by-side wings are mounted which are pivotable by hydraulic cylinders from a folded position for trailering from location to location to an open position for mowing operations, the extent of pivoting being used to vary the width of the swath to be mowed. The wings are each provided with a second hydraulic cylinder for controlling the amount of weight on the casters mounted in the individual mowers mounted to the wings and a pressure regulator which compensates for changes in the pressure in the hydraulic cylinder to support a selected portion of the weight of the wing as the portion of the weight supported by the casters changes as the casters follow the contour of the swath being mowed.

U.S. Pat. No. 5,065,566 to Gates includes a flexible line trimmer attachment for a tractor driven mower deck for trimming around trees and other objects simultaneously with mowing. A pivotal boom projects laterally from the mower deck and carries one or more trimming heads which rotate flexible lines using motive power supplied by the tractor. The boom deflects when it encounters a tree and is able to trim around more than 180.degree. of the tree circumference. A tension spring returns the boom to its normal lateral position after the tree has been cleared. The boom can be swung upwardly for compact storage by a power cylinder.

U.S. Pat. No. 4,487,003 to Mathews sets forth a multiple rotor mower having a plurality of substantially side-by-side vertically disposed rotors each having a horizontally disposed disc at their lower ends and mowing blades beneath the discs, the discs being segmented into readily detachable and replaceable disc portions for easy replacement of any disc portions damaged by contact with rocks. Closed ground engaging skids are provided beneath discs, the ground engaging skids being formed from two dish-shaped portions having a fastening flange extending outwardly from their adjacent open ends so that the bottom portion of each disc is readily detachable and replaceable providing replacement of the bottom portion of the ground engaging skid when damaged or to obtain different height adjustments of the mower rotor assemblies. The mower rotor assembly is spring suspended from an overhead support arm from the mower frame reducing the force of the ground engaging skids upon the ground.

U.S. Pat. No. 4,452,033 to Scramuzza details a lawn mower which includes a mower housing carrying a motor and including plural shafts carrying donut-like members with cutters attached thereto. The deck includes a forward portion have a protective skirt, a portion of which extends at approximately 45.degree. to the ground.

U.S. Pat. No. 4,267,686 to Heath is directed to a lawn mower comprising a plurality of flexible filament cutter elements carried on a continuous or endless driven belt. The lawn mower includes a plate-like frame having an arcuate front end formed as a portion of a perfect circle, on the underside of which is mounted a plurality of driven pulleys. A drive motor having a drive pulley is mounted on the frame, in a position to the rear of the driven pulleys. A drive belt is operatively mounted around the driven pulleys and around the drive pulley on the motor for driving the driven pulleys. The endless belt which carries the flexible filament cutter elements is mounted around the driven pulleys, whereby when the driven pulleys are rotated by the drive belt, the belt carrying the flexible cutter filaments is moved around the arcuate front end of the mower frame, and the filament cutter elements are moved outwardly by centrifugal force, for cutting engagement with grass and other vegetation, with a flail type cutting action.

U.S. Pat. No. 2,960,811 to Roesel describes a mower having retracting mower blades to provide means of changing the width of the mower itself and also a means of mowing a wider strip than the distance between the trees, posts, or other objects it may be desired to pass the mower through.

### SUMMARY

A wide-span lawn mowing mechanism includes a chassis assembly having a front tube element, a rear tube element, and a plurality of cross tubes connecting the front tube element to the rear tube element. A plurality of rotary cutting heads are suspended from the chassis assembly. A power source is included for imparting rotary motion to the cutting heads. A selectively actuatable drive system operatively connects the cutting heads to the power source.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of an embodiment of a wide-span mowing assembly in accordance with the principles of the present invention.

FIG. 2 illustrates a side elevational view of the FIG. 1 wide-span mowing assembly.

FIG. 3 illustrates a top plan view of the FIG. 1 wide-span mowing assembly.

FIG. 4 illustrates a side elevational view of the FIG. 1 wide-span mowing assembly.

FIG. 5 illustrates a detailed sectional view of a chain-drive arrangement.

FIG. 6 illustrates a detailed elevational view of a chain-drive shaft assembly.

FIG. 7 illustrates a detailed sectional view of a belt-drive arrangement.

FIG. 8 illustrates a detailed elevational view of a belt-drive shaft assembly.

### DETAILED DESCRIPTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows, will refer to the invention as depicted in the drawings.

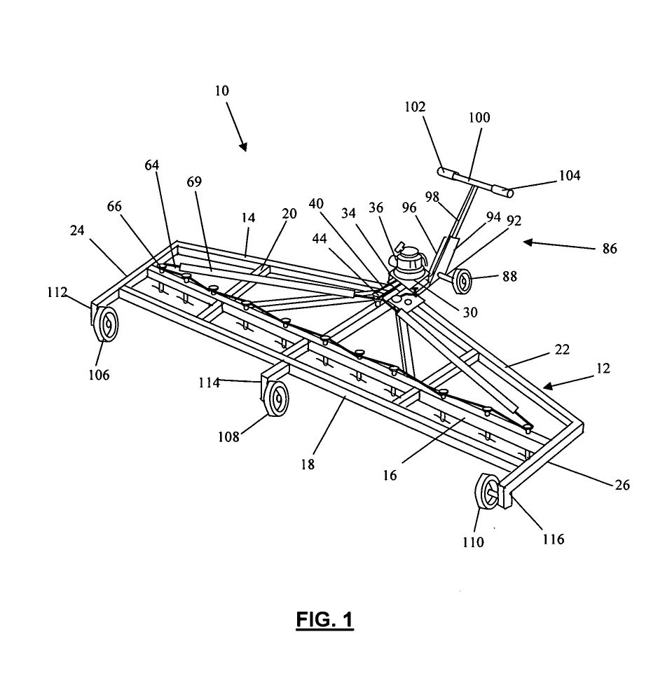

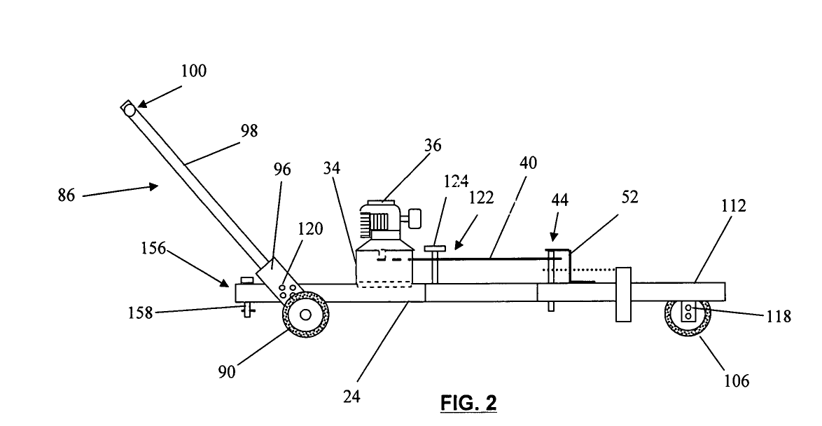

As shown in FIGS. 1 and 2, a wide-span mower assembly 10 includes a rectangular tube chassis 12. The chassis 12 is composed of front tube element 14, a rotary head mounting tube 16, and a rear tube element 18. A plurality of cross tubes connect the front tube element 14 to the, a rotary head mounting tube 16 and the rear tube element 18. The cross tubes include left and right cross tubes 20, 22 flanking a center tube 24, and left and right end tubes 26, 28. The end tubes 26, 28 extend longitudinally beyond the rear tube element 18.

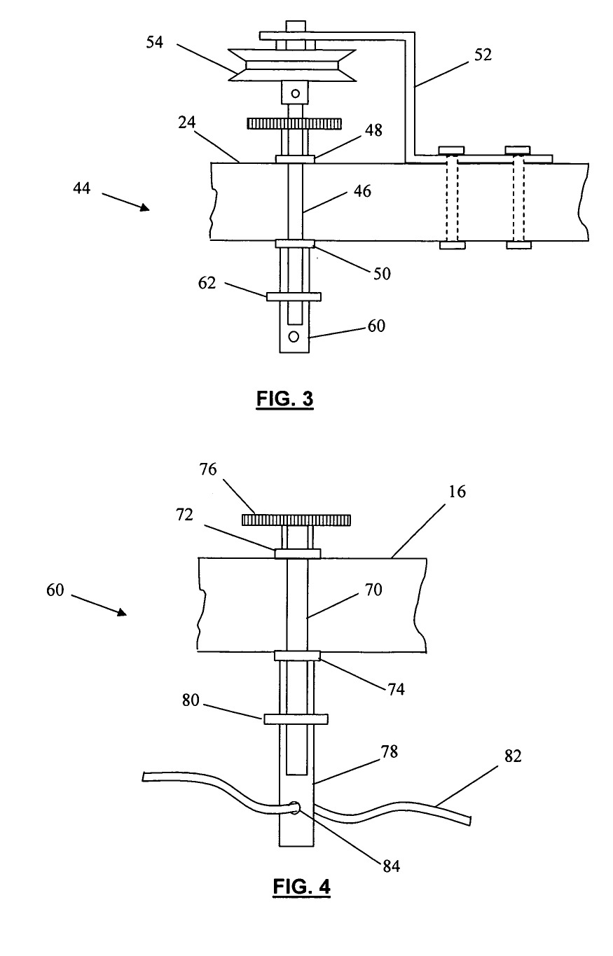

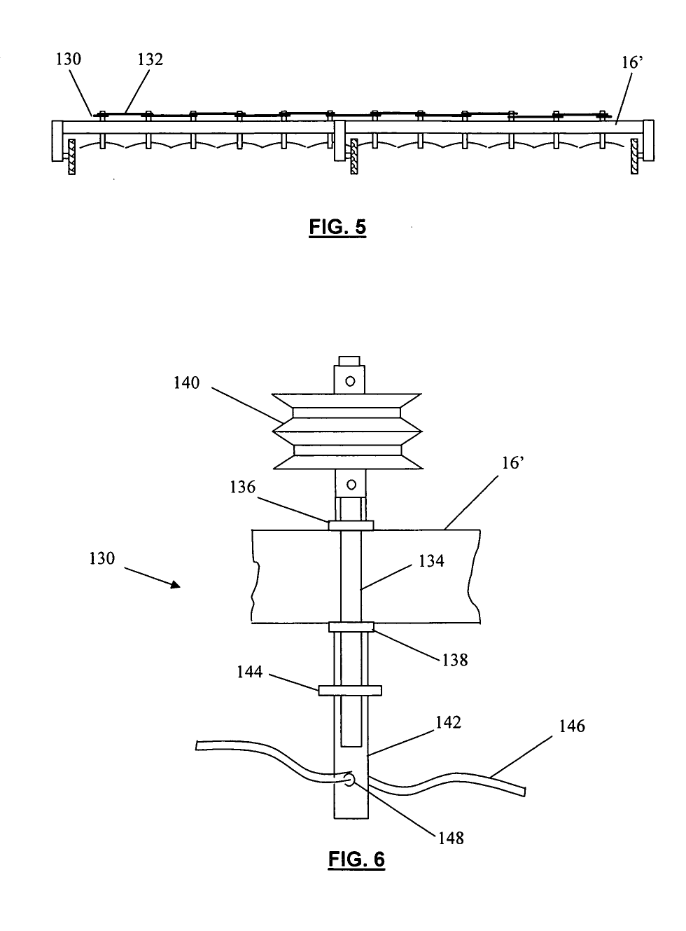

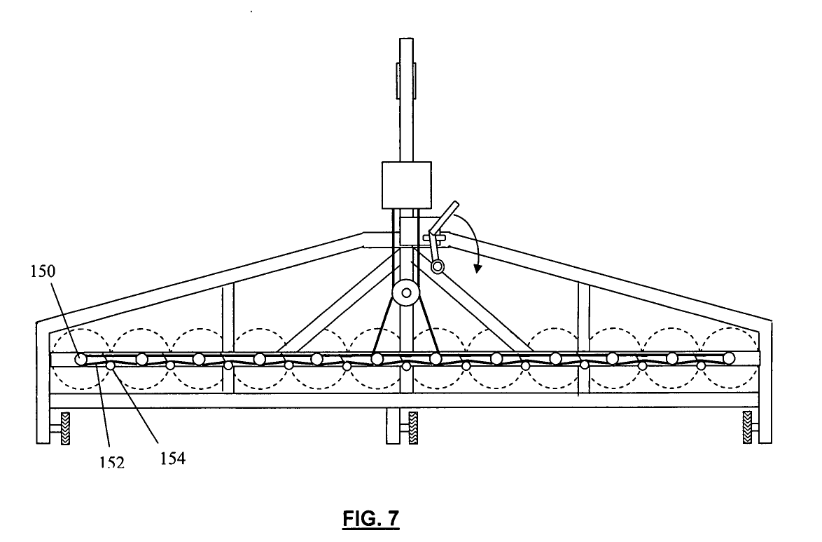

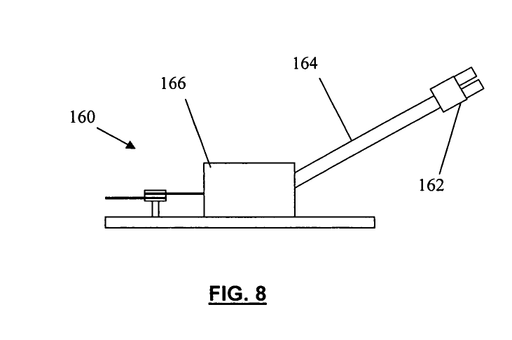

A tongue 30 extends forwardly from the front tube element 14 in approximate line with the center tube 24. The tongue 30 includes a pair of elongated slots 32 to which is bolted an engine mounting plate 34. The engine mounting plate 34 is formed as a box open at the front and back. A power source 36, here shown as an internal combustion engine, is secured to the mounting plate 34. The power source 36 can be provided as any power source capable of providing sufficient mechanical energy in a form adaptable for use with the present invention. It is contemplated that an engine such as a regular push lawn mower's engine, for example, a 3.5 HP Briggs & Stratton having a bottom output shaft, will suffice. In the place where a cutting blade would be on a regular lawn mower engine shaft is a drive pulley 38, adapted to drive a driven V-belt 40. The driven V-belt 40 is adapted to impart rotary movement to a central drive element 44 (FIG. 3). The central drive element 44 includes a central shaft 46 secured for rotation to the central tube 24 of the chassis 12, for example, via upper and lower bearing assemblies 48, 50. The central shaft 46 is secured to the chassis by a bracket 52. A pulley 54 is secured to the shaft 46, and is adapted to engage the driven V-belt 40. A chain sprocket 56 is secured for rotation with the shaft 46, for example, via one or more screws, and is set at a desired height by a spacer 58. The shaft 46 extends through the central tube 24, and is secured by an end cap 50 and pull-pin 62.

A drive chain is woven in a serpentine manner through the other eleven sprocketed rotary cutting head assemblies. A manually adjustable chain tensioner is used to control the tension of the drive chain. The rotary cutting head assemblies extend through the bottom surface of a rotary head mounting tube. The lightweight frame structure and cutting heads facilitate the construction of wide-span mower assemblies. The illustrated examples are constructed to have 11 -foot spans, but it is contemplated that wider spans are easily accomplished using the principles of the present invention.

The illustrated engine employs an “on/off” switch that must be engaged before the pull starter is used to actuate the engine. A manually operated belt tensioner is used to engage the drive pulley. A user grasps the T-handle and pushes the lever to its stop position, causing the T-handle to drop into a hole and apply pressure to the main drive belt. Rotation of the central drive element causes movement of the drive chain, thus imparting rotation to the cutting heads. When use of the mowing assembly is complete, the T-handle is lifted and put into its “stop” position, releasing belt tension, and the engine is turned off.

In an embodiment, the mower assembly is adapted for propulsion by means of a push-handle assembly. The push-handle assembly includes a pair of wheels mounted on an axle in a conventional manner. The axle extends through a pair of mounting brackets adapted for attachment to the tongue assembly of the chassis. The brackets are also used to secure a shaft, on which is secured a handle assembly having a pair of grip elements. The construction of the mower assembly in accordance with the principles of the present invention allows one person to easily push and maneuver the entire mower assembly, despite its wide span.

It is also contemplated that the mower assembly can be used in conjunction with any conventional utility vehicle, such as a tractor or ATV. Once the push handle is removed, an attachment mechanism, here illustrated as a ½″ bolt, is used to secured the mower assembly to a conventional towing tongue. The use of a spacer allows the mower assembly chassis to be leveled with the ground while the assembly is in use by being towed with any of a wide variety of vehicles. In an illustrated embodiment, the power source for the mower assembly is provided by the PTO shaft on a tractor or other vehicle. A PTO connector is provided for this purpose, and is connected to the drive shaft in a manner similar to the connection of the engine shaft.

Each of the rotary heads includes a central shaft secured for rotation to the chassis, for example, via upper and lower bearing assemblies. A double-pulley element is in turn secured for rotation with the shaft, for example, via screws. The shaft extends through the rotary head mounting tube. A cutting head element, here illustrated as a 3″ cutting head element, is fastened to the shaft by a pull pin. A cutting whip, here shown as a twelve-inch length of ¼″ plastic-coated cable, extends through a bore in the cutting head element. The cutting whip can be secured in any desired manner, such as a set-screw.

The illustrated pull-pin arrangement facilitates fast and easy replacement of the cutting head element for maintenance or replacement. When the pull-pin is removed, the cutting head element slides off of the bottom of the shaft

The mowing height of the mower assembly can be adjusted by setting the height of the ground-engaging wheels. For this purpose, pluralities of holes at different heights are provided in the wheel supports of the chassis, and in the handle mounting brackets, if used. In the illustrated example, holes are provided to facilitate either a 2″ or 3″ cutting height, but it is contemplated that higher and lower mounting holes can also be provided as desired.

The wide-span mower assembly is also advantageous in that it is easily and compactly storable. The engine mounting plate is secured to the tongue in elongated slots to allow position adjustment of the engine, and to accommodate engines from various manufacturers. Thus, for storage, the engine and mounting plate are easily unbolted and removed from the mower assembly, and can be transported separate from the mower assembly, for example, for winter maintenance. With the engine and push handle assembly removed, the chassis and components that remaining mounted thereto can easily be raised to a vertical position for storage against a wall or similar support structure.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. A wide-span lawn mowing mechanism comprising the following:
a chassis assembly including a front tube element, a rear tube element, and a plurality of cross tubes connecting the front tube element to the rear tube element;
a plurality of rotary cutting heads suspended from the chassis assembly;
a power source for imparting rotary motion to the cutting heads; and
a selectively actuatable drive system operatively connecting the cutting heads to the power source.

2. A lawn mowing mechanism in accordance with claim 1, wherein the power source is supported by the chassis assembly.

3. A lawn mowing mechanism in accordance with claim 2, wherein the power source comprises an internal combustion engine.

4. A lawn mowing mechanism in accordance with claim 1, wherein the power source comprises a PTO drive of a vehicle.

5. A lawn mowing mechanism in accordance with claim 1, wherein the plurality of cross tubes includes a center tube, and a plurality of left side tubes, and a plurality of right side tubes.

6. A lawn mowing mechanism in accordance with claim 6, wherein the plurality of left side tubes includes a left end tube, and the plurality of right side tubes includes a right end tube.

7. A lawn mowing mechanism in accordance with claim 6, wherein the wherein the left end tube and the right end tube extend longitudinally beyond the rear tube element.

8. A lawn mowing mechanism in accordance with claim 1, further comprising a tongue extending forwardly from the front tube element.

9. A lawn mowing mechanism in accordance with claim 8,further comprising a mounting plate secured to the tongue, the mounting plate being adapted and constructed to secure the power source.

10. A lawn mowing mechanism in accordance with claim 8, wherein the tongue includes a mounting mechanism adapted and constructed to selectively and alternatively connect a manual push mechanism and a powered vehicle to the lawn mowing mechanism.

11. A lawn mowing mechanism in accordance with claim 10, wherein the mounting mechanism includes a height adjustment arrangement.

12. A lawn mowing mechanism in accordance with claim 1, wherein the drive system comprises the following:
a central drive element operatively connected to the power source; and
a distribution drive arrangement connected to the central drive element and to each of the rotary cutting heads.

13. A lawn mowing mechanism in accordance with claim 12, wherein the central drive element and the distribution drive arrangement comprise belt drives.

14. A lawn mowing mechanism in accordance with claim 13, further comprising a belt engagement lever connected to the central drive element, whereby actuation of the belt engagement lever selectively actuates the drive system.

15. A lawn mowing mechanism in accordance with claim 13, further comprising at least one spring-loaded belt tensioner connected to the distribution drive arrangement.

16. A lawn mowing mechanism in accordance with claim 15, further comprising at least one idler pulley connected to the distribution drive arrangement.

17. A lawn mowing mechanism in accordance with claim 1, wherein the chassis assembly further comprises a rotary head mounting tube connected to the cross tubes, wherein the rotary cutting heads are mounted on the rotary head mounting tube.

18. A lawn mowing mechanism in accordance with claim 17, wherein each rotary cutting head comprises the following:
a rotary shaft extending through the rotary head mounting tube;
a drive engagement element mounted on the shaft at a first end of the shaft; and
a cutting element mounted on a second end of the shaft.

19. A lawn mowing mechanism in accordance with claim 18, wherein each of the shafts is mounted for rotation in the rotary head mounting tube via at least one bearing assembly.

20. A lawn mowing mechanism in accordance with claim 19, wherein each shaft further comprises a pull pin mechanism adapted and constructed to removably secure the shaft to the rotary head mounting tube.
